(19) United States
(12) Patent Application Publication
(10) Pub. No.: US 2009/0085427 A1
(43) Pub. Date: Apr. 2, 2009

(54) ELECTRICAL POWER GENERATION FROM FLUID FLOW

(75) Inventors: Ruba T. Borno, Ann Arbor, MI (US); Michel M. Maharbiz, El Cerrito, CA (US); Joseph D. Steinmeyer, Cambridge, MA (US)

Correspondence Address: HOWARD & HOWARD ATTORNEYS PLLC, 450 West Fourth Street, Royal Oak, MI, 48067, US

(73) Assignee: THE REGENTS OF THE UNIVERSITY OF MICHIGAN, Ann Arbor, MI (US)

(21) Appl. No.: 12/243,624

(22) Filed: Oct. 1, 2008

Related U.S. Application Data
(60) Provisional application No. 60/976,614, filed on Oct. 1, 2007.

(51) Int. Cl. H02N 1/00

(52) U.S. Cl. 310/308

(57) ABSTRACT

A power generation system produces electrical power from the flow of a fluid, such as water. Particularly, the fluid flow may be driven by evaporation of the fluid. A conduit for conveying the fluid is defined through a substrate includes at least one opening for allowing evaporation of the fluid. A dielectric substance is disposed within the conduit and impelled through the conduit by the evaporation of the fluid. The dielectric substance has a permittivity different from the permittivity of the fluid. A variable capacitor has a first plate and a second plate separated by the conduit. As such, the capacitance of the variable capacitor varies as the fluid and the dielectric substance flow between the plates. A charge pump circuit is electrically connected to the variable capacitor to store charge generated by the variable capacitor into a storage capacitor.

### CROSS REFERENCE TO RELATED APPLICATION

This application claims the benefit of U.S. Provisional Application No. 60/976,614, filed Oct. 1, 2007, which is hereby incorporated by reference.

### STATEMENT REGARDING FEDERALLY SPONSORED RESEARCH OR DEVELOPMENT

This invention was made with government support under Grant No. 0556271 awarded by the National Science Foundation. The government has certain rights in the invention.

### BACKGROUND OF THE INVENTION

1. Field of the Invention

The subject invention relates to an energy scavenging system. Specifically, the subject invention relates to a system for electrical power generation from fluid flow, including fluid flow driven by evaporation.

2. Description of the Related Art

As energy prices continue to rise and concerns over the global climate change due to conventional energy sources (e.g., petroleum, coal, etc.) become more recognized, there is a desire for lower cost sources of energy that provide less impact on the environment. Specifically, development of energy scavenging devices, which do not require the constant consumption of “fossil fuels”, has been progressing over the past decades.

Such energy scavenging devices include solar/photo-voltaic cells which translate natural or synthetic light into electricity. Various kinetic energy harvesting techniques have also been developed to take advantage of environmental vibrations. Furthermore, radioisotope generators and thermoelectric transduction have also been investigated to generate electricity.

The evaporation of water, and other fluids, into the atmosphere is a well known phenomenon and an important part of the hydrologic cycle provided by nature. The evaporation of water from plants is commonly referred to as transpiration and typically occurs through leaves of the plant. Transpiration allows the diffusion of carbon dioxide from the air as well as providing cooling effects to the plant and allowing the flow of nutrients therethrough.

Research into the mechanisms surrounding transpiration have provided insights into how the structures of nature can be utilized to provide benefits to humanity. For instance, microactuators driven by fluid evaporation have been shown to generate force, which may have numerous practical applications. However, despite the research into generating work from fluid evaporation, there remains an opportunity for a system to generate electricity from such fluid evaporation.

### SUMMARY OF THE INVENTION AND ADVANTAGES

The subject invention provides a power generation system for producing electrical power from the evaporation of a fluid having a first permittivity. The system includes a conduit for conveying the fluid. The conduit defines at least one opening for allowing evaporation of the fluid through the opening. A dielectric substance is disposed within the conduit and impelled through the conduit by the evaporation of the fluid. The dielectric substance has a second permittivity different from the first permittivity of the fluid. The system also includes a variable capacitor having a first plate and a second plate separated by the conduit. As such, the capacitance of the variable capacitor varies as the fluid and the dielectric substance flow between the plates.

Clearly, the system of the present invention provides numerous advantages over the prior art. First and foremost, the system is able to produce electricity from natural resources, i.e., the system provides “renewable energy”. Specifically, the system uses evaporation of a fluid, which is primarily driven by the natural heating of the sun, to produce electricity. Furthermore, the system, during operation using water as the fluid, produces no harmful emissions such as carbon dioxide. Conversely, the system produces only water vapor as a by-product due to the evaporation of the water.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a first embodiment of a power generation system according to the present invention;

FIG. 2 is a cross-sectional top view of the first embodiment of the system showing a conduit having a main section branching into a plurality of smaller sub-sections to encourage evaporation of a fluid;

FIG. 3 is a perspective view of a second embodiment of the system according to the present invention showing a porous material to encourage evaporation of the fluid;

FIG. 4 is a perspective view of a third embodiment of the system according to the present invention showing a micro-water wheel for recirculating a dielectric substance;

FIG. 5 is a cross-sectional view of first and second layers of a substrate forming the conduit;

FIG. 6 is an electrical schematic diagram a first configuration of an energy conversion circuit having a storage capacitor;

FIG. 7 is an electrical schematic diagram of a second configuration of the energy conversion circuit having the storage capacitor, an initial charge capacitor, and a pair of diodes;

FIG. 7A is an electrical schematic diagram showing the second configuration of the energy conversion circuit operating at an initial condition;

FIG. 7B is an electrical schematic diagram showing the second configuration of the energy conversion circuit operating at a voltage accumulation condition;

FIG. 7C is an electrical schematic diagram showing the second configuration of the energy conversion circuit operating at a no accumulation condition; and

FIG. 8 is charts showing simulation results for the system.

### DETAILED DESCRIPTION OF THE INVENTION

Referring to the Figures, wherein like numerals indicate corresponding parts throughout the several views, a power generation system 10 for producing electrical power from the evaporation of a fluid 12 is shown.

The fluid 12 in the illustrated embodiments is water. Water is ideal, as it is the most abundant and easily obtainable liquid on Earth. However, in other embodiments, other evaporative fluids 12 may also be suitable. The fluid 12 has a first permittivity. Those skilled in the art realize that the term “permittivity” refers to how an electric field interacts with a material, in this case, the fluid 12.

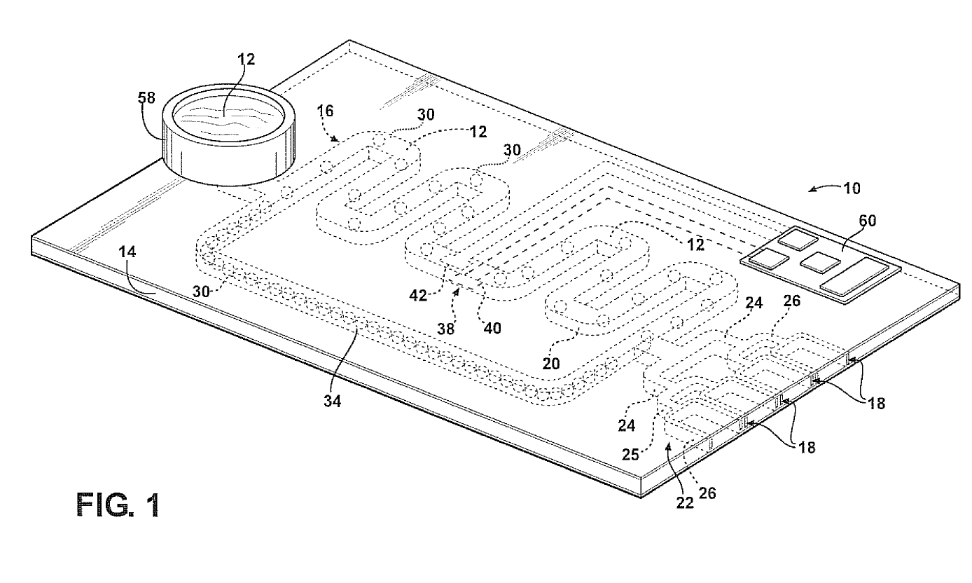

Referring to FIGS. 1-5, the system 10 includes a substrate 14 defining a conduit 16. The conduit 16 conveys the fluid 12. Said another way, the fluid 12 flows through the conduit 16. In one embodiment, the conduit 16 forms a meandering line pattern, i.e., the conduit 16 travels back and forth. Of course, in other embodiments, the conduit 16 may form differing shapes and patterns as is recognized by those skilled in the art.

The conduit 16 includes at least one opening 18 for allowing evaporation of the fluid 12 through the opening 18. That is, the substrate 14 defines the at least one opening 18 as part of the conduit 16. The opening 18 opens the conduit 16 to air, the atmosphere, or other medium in which the fluid 12 may evaporate.

A fluid supply 58 is in fluidic communication with the conduit 16 for storing the fluid 12 and providing the fluid 12 to the conduit 16. In the illustrated embodiments of FIGS. 1-4, the fluid supply 58 is a reservoir containing the fluid 12. However, those skilled in the art realize other suitable techniques for delivering fluid 12 to the conduit 16. Furthermore, the fluid supply 58 may be equipped with a rain collection device (not shown) for collecting natural precipitation.

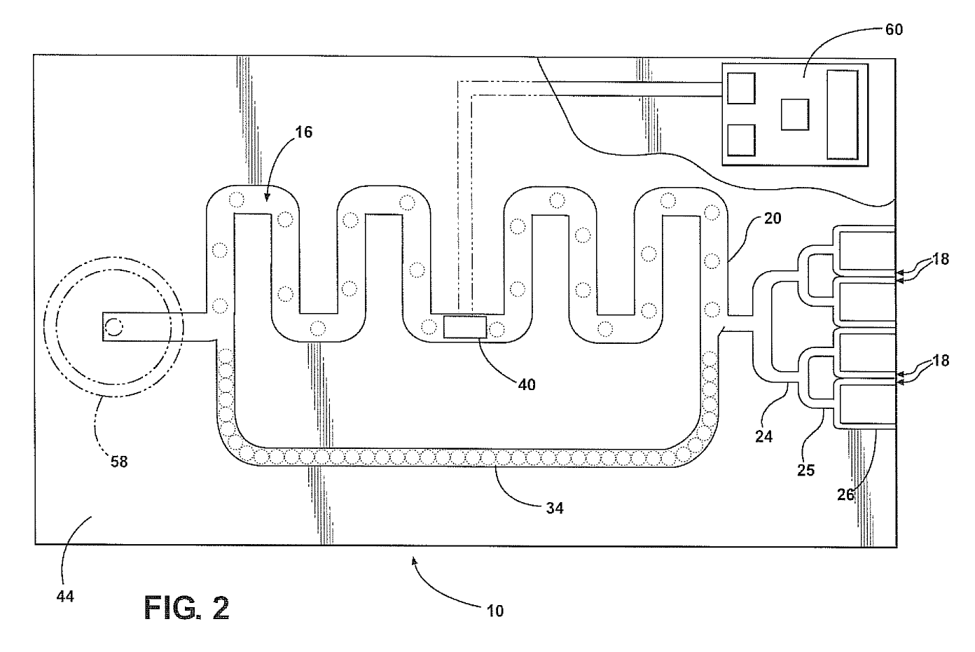

In a first embodiment, as shown in FIGS. 1 and 2, a plurality of openings 18 is utilized. Furthermore, in the first embodiment, the conduit 16 includes a main section 20 and a plurality of sub-sections 22. These sub-sections 22 are arranged as vascular-type network (not separately numbered). Specifically, a set of first sub-sections 24 branch from the main section 20, a set of second sub-sections 25 branch from the first sub-sections 24, and a set of third sub-sections 26 branch from the second sub-sections. Clearly, this branching of sub-sections 22 may occur numerous times and is not limited to the first, second, and third sub-sections 24, 25, 26 described above. More specifically, in the first embodiment, the set of first sub-sections 24 utilizes a pair of branches extending from the main section 20. The set of second sub-sections 25 utilizes four branches; a pair of branches extending from each of the branches of the first sub-section 24. The set of third sub-sections 26 utilizes eight branches; a pair of branches extending from each of the branches of the second sub-section 25.

Preferably, in the first embodiment, the main section 20 and sub-sections 22 are sized to optimize for the lowest hydraulic resistance. More preferably, in the first embodiment, the main section 20 and sub-sections 22 are sized in accordance with Murray's Law. This scientific principle defines the geometric algorithm that plant xylem networks obey in order to minimize hydraulic resistance and obtain maximum flow rates. More specifically, Murray's Law states that the cube of the radius of the main section 20 equals the sum of the cubes of the radii of the sub-sections 22 and is expressed with the equation

r₀³=r₁³+r₂³+r₃³

where r₀ is the radius of the main section 20, r₁ is the sum of the radii of the first set of sub-sections 24, r₂ is the sum of the radii of the second set of sub-sections 25, and r₃ is the sum of the radii of the third set of sub-sections 26. Of course, this equation may be modified in situations where there are more or less than three sets of sub-sections 22. Furthermore, in accordance with the principles described above, a cross-sectional area of each of the sub-sections 22 is less than a cross-sectional area of the main section 20.

In the first embodiment, the openings 18 defined by the subsections 22 preferably each have a diameter between 0.1 and 100 micrometers (μm). More preferably, the diameters of the openings 18 are between 1 and 10 μm, as these diameters provided the highest volumetric flow rate of the fluid 12 in various experimental tests of the system 10.

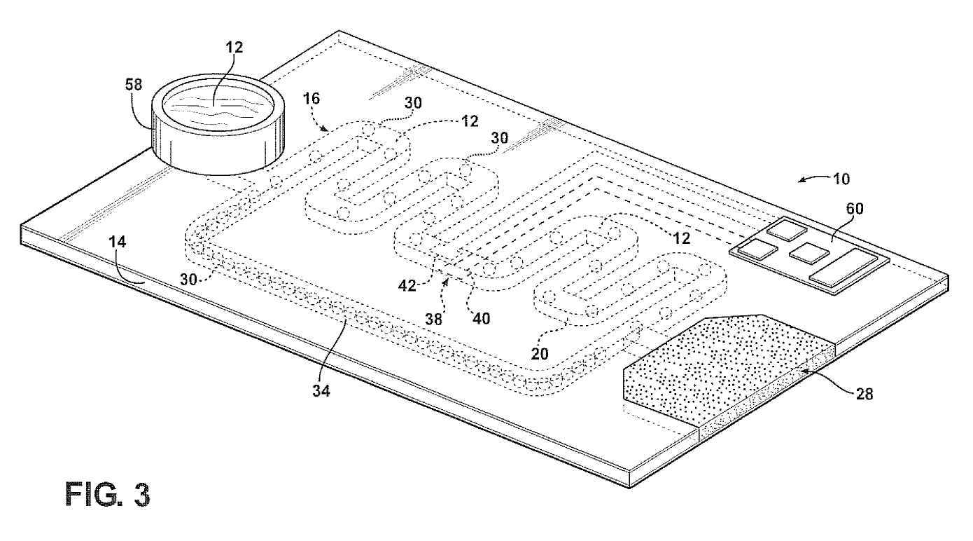

In a second embodiment, as shown in FIG. 3, a porous material 28 is in fluidic communication with the opening 16 to encourage evaporation of the fluid 12. This porous material 28 may be high-fired alumina (i.e., aluminum oxide), silica (i.e., silicon dioxide), or other substances known to those skilled in the art. As with the openings of the subsections 22 of the first embodiment, the diameter of the pores of the porous material 28 is also preferably between 0.1 and 100 μm and more preferably between 1 and 10 μm.

The fluid 12 moves through the conduit 16 based on the difference in the chemical potential of the fluid 12 as opposed to an applied pressure. The fluid potential drop is dominated by the surface tension of menisci at the openings 16. Since the contributions to the fluid potential from atmospheric vapor and gravity at the fluid supply 58 are smaller than that due to surface tension, the net liquid flow is to the openings 16. Furthermore, the capillary pressure at the openings 16 prevents the openings 16 from drying out.

The system 10 also includes a dielectric substance 30 disposed within the conduit 16. The dielectric substance 30 is impelled through the conduit 16 by the evaporation of the fluid 12. That is, the dielectric substance 30 moves through the conduit 16 as the fluid 12 evaporates through the opening 18 or openings 18. The dielectric substance 30 has a second permittivity that is different from the first permittivity of the fluid 12. As such, the dielectric substance 30 interacts with an electric field differently than the fluid 12.

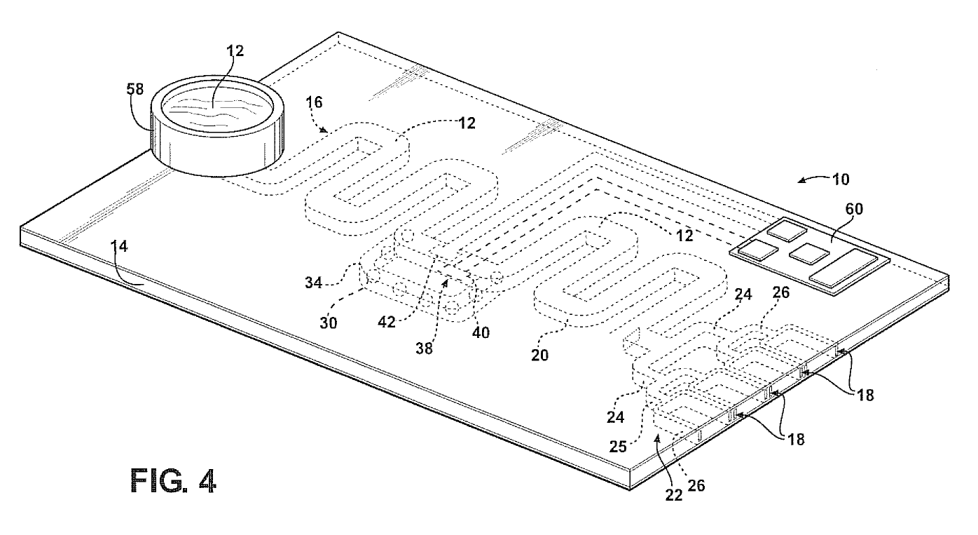

In the illustrated embodiments, the dielectric substance 30 is implemented as a plurality of beads (not separately numbered) formed of a polymer. Preferably, the beads are formed of polystyrene. However, those skilled in the art will realize other suitable substances for the beads that provide the system with a second permittivity different from the first permittivity of the fluid. FIGS. 1-4 show the system 10 having a return channel 34 to recycle the beads as the fluid 12 evaporates, such that the beads may flow through the conduit 16 in perpetuity. Of course, the system 10 preferably includes mechanisms (not shown) to prevent flow of the fluid 12 through the return channel 34. Furthermore, a third embodiment of the system 10, shown in FIG. 4, the return channel 34 and conduit 16 form a recirculating wheel (not separately numbered), also referred to as a micro-water water wheel.

In other embodiments, the dielectric substance 30 is implemented as bubbles (not shown) of a gas. The gas may be air; however, other suitable gasses for providing a different permittivity from the fluid 12 are realized by those skilled in the art. Furthermore, those skilled in the art will realize other techniques to implement the dielectric substance 30 other than the beads or gas bubbles described above.

The system 10 also includes a variable capacitor 38. The variable capacitor 38 includes a first plate 40 and a second plate 42 separated by the conduit 16. As such, the capacitance of the variable capacitor 38 varies as the fluid 12 and the dielectric substance 30 flow between the plates 40, 42. The changing permittivity of the fluid 12 and the dielectric substance 30, which occurs due to the evaporation of the fluid 12, permits electrical power generation, i.e., electric scavenging, from the system 10. The plates 40, 42 are formed of an electrically conductive material, such as, but not limited to, a metal.

The system 10 may utilize multiple variable capacitors 38. That is, multiple sets of plates 40, 42 may be utilized at various locations along the conduit 16. Preferably, the multiple variable capacitors 38 are electrically connected in parallel with one another. For simplicity of description, only a single variable capacitor 38 is shown and only a single variable capacitor 38 will be described further herein.

In the illustrated embodiment, the substrate 14 comprises a first substrate layer 44 and a second substrate layer 46. Preferably, the conduit 16 is etched in at least one of the substrate layers 44, 46. The substrate layers 44, 46 may be formed of any suitable material. In experimentations, the substrate layers 44, 46 were formed of glass with the conduit 16 formed using a wet etching process. However, other materials, such as silicon, may also be utilized.

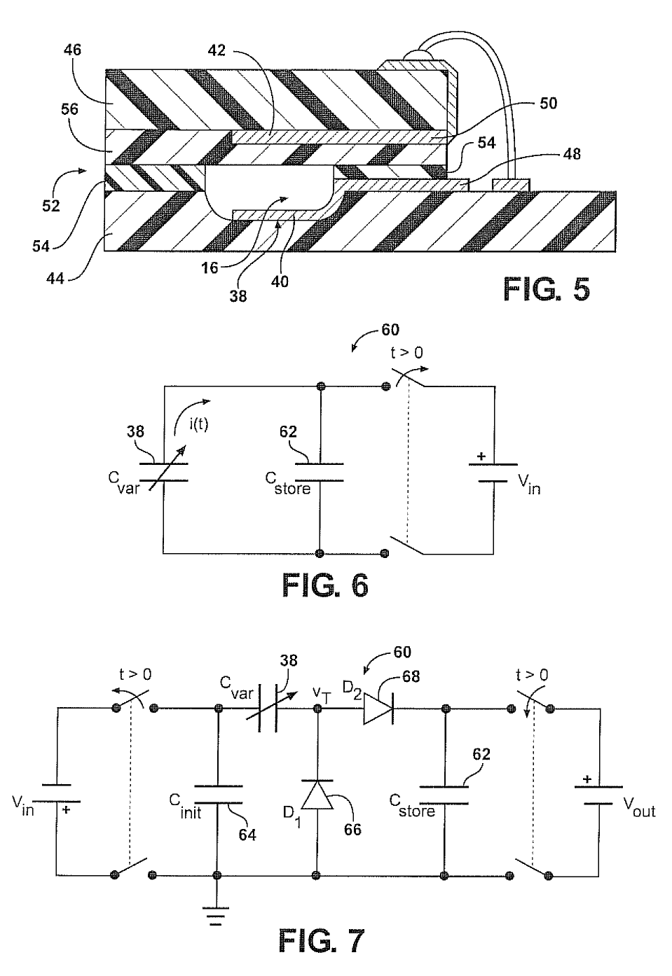

Referring to FIG. 5, in an illustrated embodiment, the conduit 16 is etched only in the first substrate layer 44. In experimentations, where the first substrate layer 44 is formed of glass, the conduit 16 was etched using Hydrofluoric acid, Nitric acid, and distilled water to achieve a depth of about 45 to 75 μm. However, those skilled in the art realize that other substrates could be used, including, but not limited to, printed circuit board (PCB) materials and silicon wafers that can be etched isotropically or anisotropically using standard techniques.

In the embodiment of FIG. 5, a first conductive layer 48 is applied to the first substrate layer 44 and a second conductive layer 50 is applied to the second substrate layer 46. The first conductive layer 48 extends into the portion of the first substrate layer 44 defining the conduit 16. The plates 40, 42 of the variable capacitor 38 are formed by a portion of each of the conductive layers 48, 50. Other portions of the conductive layers 48, 50 are utilized to provide electrical connection from the plates 40, 42 to other electrical components described below. The conductive layers 48, 50, and accordingly, the plates 40, 42, may be formed of titanium (Ti) and platinum (Pt). In experimentation, the conductive layers 48, 50 were formed of 300 Å of Ti and 1000 Å of Pt. However, those skilled in the art realize other metals and conductive materials of various dimensions may be utilized to form the conductive layers 48, 50.

Preferably, at least one non-conductive layer 52 is disposed between the conductive layers 48, 50. In the illustrated embodiment of FIG. 5, the at least one non-conductive layer 52 is implemented as a first polymer layer 54 and a second polymer layer 56. The first polymer layer 54 comprises polydimethylsiloxnae (PDMS) and is disposed on the first substrate layer 44. However, toluene is disposed on a region (not numbered) surrounding the conduit 16 such that the PDMS is not disposed within the conduit 16 and therefore not disposed between the plates 40, 42 of the variable capacitor 38. The PDMS of the first polymer layer 54 may be Sylgard 184 manufactured by Dow Coming of Midland, Mich. However, other suitable polymers or manufacturers of PDMS may also be acceptable.

The second polymer layer 56 comprises Parylene and is disposed on the second substrate layer 46. Specifically, the second polymer layer 56 is formed of Parylene C manufactured by SCS Coatings of Indianapolis, Ind., and has a width of about 1.2 μm. Unlike the first polymer layer 54, the second polymer player 56 is disposed between the plates 40, 42 of the variable capacitor 38. The polymer layers 54, 56 are bonded together, such that the substrate layers 44, 46 are affixed to one another, thus enclosing the conduit 16. Additional non-conductive dielectrics and/or insulators could be used, including, but not limited to, Silicon dioxide, both deposited and thermally grown, as well as other polymers.

As shown in FIGS. 1-4, in the illustrated embodiment, the reservoir fluid supply 58 is affixed to the second substrate layer 46. The second substrate layer 46 defines a hole (not numbered), allowing the fluid 12 to enter the conduit 16.

At least two techniques may be utilized to generate electricity with the system 10. One technique, referred to as the “constant voltage technique”, requires that the capacitance of the variable capacitor 38 increase in order to harvest energy from the change in capacitance. Another technique, referred to as the constant charge technique, requires that the capacitance decrease from the initial value in order to harvest energy from the change in capacitance. Both techniques utilize a separate voltage source to provide an initial charge to the variable capacitor 38. However, the constant voltage technique requires an additional voltage source to maintain a constant voltage across the variable capacitor 38. Therefore, the constant charge technique is preferred and will be discussed in greater detail below.

The system 10 includes an energy conversion circuit 60 electrically connected to the variable capacitor 38 for converting the energy produced by the variable capacitor 38 into electricity that can be used by a load. The energy conversion circuit 60 includes a storage capacitor 62 electrically connected with the variable capacitor 38 for storing a charge produced by the system 10. In one embodiment of the invention, as shown in FIG. 5, the storage capacitor 62 is connected in parallel with the variable capacitor 38.

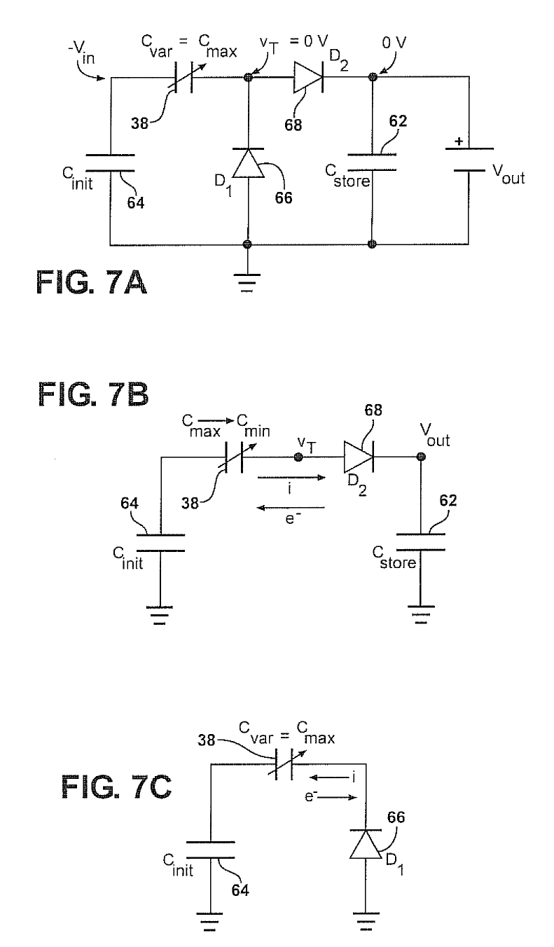

However, a preferred embodiment of the energy conversion circuit 60 is shown in FIG. 7. This embodiment may be referred to as a “charge pump circuit” and utilizes an initial charge capacitor 64 electrically connected to the variable capacitor 38. A first diode 66 and a second diode 68 are also electrically connected to the variable capacitor 38. The storage capacitor 62 is also electrically connected to the first and second diodes 66, 68.

The preferred embodiment operates in three conditions: an initial condition, a voltage accumulation condition, and a no accumulation condition. At the initial condition, as shown in FIG. 7A, the initial charge capacitor 64 and the variable capacitor 38 are charged to a negative initial voltage. This initial charge is only applied once to the circuit and is provided by a power supply Vᵢₙ. Further charging of the initial charge capacitor 64 is typically not necessary. Also, at this initial condition, only the fluid 12 is disposed between the plates of the variable capacitor 38. As such, the variable capacitor 38 has a maximum capacitance of Cₘₐₓ.

The voltage accumulation condition occurs as the dielectric substance 30 moves into the area between the plates 40, 42. An electrical schematic of the voltage accumulation condition is shown in FIG. 7B. At this time, the capacitance of the variable capacitor 38 changes from the maximum capacitance Cₘₐₓ to a minimum capacitance Cₘᵢₙ. The change in capacitance ΔCᵥₐᵣ of the variable capacitor results in an increase of voltage across the storage capacitor 62. That is, the second diode 68 conducts current to the storage capacitor 62 while the first diode 66 blocks the flow of current.

The no accumulation condition occurs as the dielectric substance 30 moves out of the area between the plates 40, 42. An electrical schematic of the no accumulation condition is shown in FIG. 7C. At this time, the capacitance of the variable capacitor 38 changes from the minimum capacitance Cₘᵢₙ back to the maximum capacitance Cₘₐₓ. The first diode 66 conducts current to the storage capacitor 62.

An electrical load (not shown) may be electrically connected across the storage capacitor 62 to receive an output voltage Vₒᵤₜ. The electrical load may be selectively switched to prevent a constant drain on the storage capacitor 62.

Selection and sizing of the various electrical components of the system 10, such as the capacitors 38, 62, 64, should be based on many factors. These factors include, but are not limited to, the expected evaporation flow rate for the fluid 12, the voltage and current required by the electrical load, and the acceptable amount of time to recharge the storage capacitor 62.

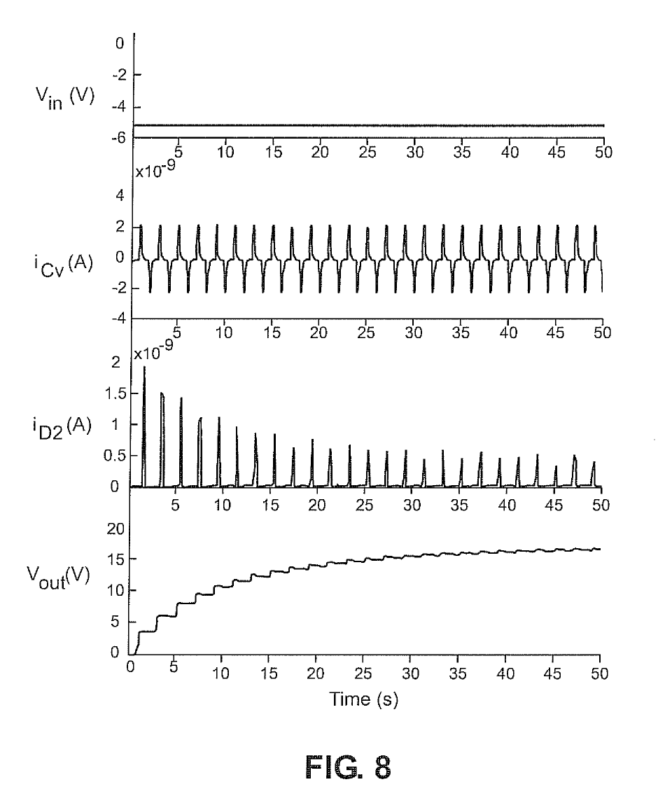

FIG. 8 shows simulation results for one embodiment of the system 10. In this embodiment, the storage capacitor 62 has a capacitance of 100 pF, the volumetric flow rate of the fluid 12 is 100 μL/min, and the initial voltage across the initial capacitor 64 is −5 V. This embodiment provides a maximum voltage of 17 V across the storage capacitor 62 with a maximum predicted energy of 0.14 nJ stored by the storage capacitor 62. Assuming the electrical load has a resistance of 100 kΩ, the system 10 provides a maximum instantaneous power of about 3 mW.

Those skilled in the art realize numerous applications for the power generation system 10 described herein. For example, the system 10 may be utilized to power a sensor (not shown). This is particularly useful where the sensor is located in a remote location where other sources of electricity are not available.

The principles for generating electricity described herein may also be applied in situations the flow of fluid 12 is not necessarily driven by the evaporation of the fluid 12. Said another way, other natural or artificial sources may propel the fluid 12 and the dielectric substance 30 through the conduit 16 and still charge the storage capacitor 62. For instance, the fluid supply 58 may be pressurized, such as is common among commercial water supplies. The fluid supply 58 may also be provided by the natural flow of water, such as a stream or river. Of course, other techniques to propel fluid 12 are known to those skilled in the art.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claim.

What is claimed is:

1. A power generation system for producing electrical power from the evaporation of a fluid having a first permittivity, said system comprising:
a conduit for conveying the fluid;
said conduit defining at least one opening for allowing evaporation of the fluid through said opening;
a dielectric substance disposed within said conduit and impelled through said conduit by the evaporation of the fluid;
said dielectric substance having a second permittivity different from the first permittivity of the fluid; and
a variable capacitor having a first plate and a second plate separated by said conduit such that the capacitance of the variable capacitor varies as the fluid and said dielectric substance flow between said plates.

2. A system as set forth in claim 1 wherein said conduit includes a main section and a plurality of sub-sections.

3. A system as set forth in claim 2 wherein said sub-sections define a plurality of openings.

4. A system as set forth in claim 2 wherein a cross-sectional area of at least one of said sub-sections is less than a cross-sectional area of said main section.

5. A system as set forth in claim 2 wherein said sub-sections include a first set of sub-sections and a second set of sub-sections.

6. A system as set forth in claim 2 wherein each of said openings has a diameter between 0.1 and 100 micrometers.

7. A system as set forth in claim 1 wherein said dielectric substance is a plurality of beads formed of a polymer.

8. A system as set forth in claim 7 wherein said beads are formed of polystyrene.

9. A system as set forth in claim 1 wherein said dielectric substance is bubbles of a gas.

10. A system as set forth in claim 1 wherein said substrate comprises a first layer and a second layer and wherein said conduit is etched in at least one of said layers.

11. A system as set forth in claim 10 wherein said plates are formed of titanium and platinum disposed on said layers.

12. A system as set forth in claim 11 further comprising at least one non-conductive layer disposed between said layers of substrate.

13. A system as set forth in claim 1 wherein the fluid is water.

14. A system as set forth in claim 1 further comprising a storage capacitor electrically connected in parallel with said variable capacitor for storing a charge produced by said system.

15. A system as set forth in claim 1 further comprising a fluid supply in fluidic communication with said conduit for providing the fluid to said conduit.

16. A system as set forth in claim 1 wherein said variable capacitor is further defined as a plurality of variable capacitors.

17. A system as set forth in claim 1 further comprising an energy conversion circuit electrically connected to said variable capacitor.

18. A system as set forth in claim 17 wherein said energy conversion circuit includes an initial capacitor, a storage capacitor, and a pair of diodes.

19. A system as set forth in claim 1 wherein said opening is further defined as a plurality of openings.

20. A power generation system for producing electrical power from the flow of a fluid having a first permittivity, said system comprising:
a conduit for conveying the fluid;
a dielectric substance disposed within said conduit and impelled through said conduit by the flow of the fluid;
said dielectric substance having a second permittivity different from the first permittivity of the fluid; and
a variable capacitor having a first plate and a second plate separated by said conduit such that the capacitance of the variable capacitor varies as the fluid and said dielectric substance flow between said plates.

21. A system as set forth in claim 20 wherein said dielectric substance is a plurality of beads formed of a polymer.
